(19) United States
(12) Patent Application Publication
(10) Pub. No.: US 2026/0101239 A1
(43) Pub. Date: Apr. 9, 2026

(54) METHODS, ARCHITECTURES, APPARATUSES AND SYSTEMS FOR EFFICIENT SENSING IN WIRELESS NETWORKS

(71) Applicant: InterDigital Patent Holdings, Inc., Wilmington, DE (US)

(72) Inventors: Jung Je Son, Warrington, PA (US); Magurawalage Chathura Madhusanka Sarathchandra, London (GB); Taimoor Abbas, Sainte-Julie (CA); Anuj Sethi, Ottawa (CA); Zhibi Wang, Woodridge, IL (US); Guanzhou Wang, Brossard (CA)

(21) Appl. No.: 18/906,059

(22) Filed: Oct. 3, 2024

(51) Int. Cl. H04W 28/24; H04W 4/38; H04W 64/00

(52) U.S. Cl. CPC H04W 28/24; H04W 4/38; H04W 64/00

(57) ABSTRACT

Procedures, methods, architectures, apparatuses, systems, devices, and computer program products for providing a sensing service in an integrated sensing and communication network are disclosed. Sensing entities in the network are assigned to one or more groups. A first group of sensing entities provides a set of sensing measurements, and a sensing result is determined from those measurements. The quality of the sensing result is compared to a required quality of the sensing service. If the sensing result falls below the required quality of service, a second set of entities is activated to provide a second set of measurements. An updated sensing result is determined based on the first and second set of sensing measurements. The efficiency of the sensing service is improved owing to the second group of sensing entities only being activated when the first set of sensing entities fail to provide the required quality of sensing service.

### TECHNICAL FIELD

The present disclosure is generally directed to the fields of communications, software and encoding, including, for example, to methods, architectures, apparatuses, systems related to sensing in wireless networks, and more particularly to performing efficient sensing operations.

### BACKGROUND

Conventional cellular wireless networks provide a facility for establishing the position of a WTRU connected to the network. Recently, investigations have been carried out into the feasibility of operating a wireless network to establish the position of an object not connected to the network by operating a wireless network node to observe reflections of wireless signals transmitted by the same wireless network node or another wireless network node.

### SUMMARY

In certain representative embodiments, a system within an integrated sensing and communications network may perform a sensing method using a multi-step operation. The location at which the sensing is to be performed, and a level of Quality of Service for the sensing (e.g. relating to required location accuracy in an object-tracking service etc.) may be specified in a request to perform a sensing service received by the system. The system may select sensing entities for use in providing the requested sensing service in accordance with the location at which the service is required, and the Quality of Service requested. In addition, the system may arrange the selected sensing entities into groups. The system may trigger at least one of the groups to perform a sensing operation, receive sensing measurements, determine a sensing result and compare the quality of the sensing result to the requested Quality of Service for the sensing service. If the system finds that the quality of the sensing result does not meet the requested quality of service, then the system may trigger a sensing operation by another group of sensing entities in order to obtain further sensing measurements and thereby determine a sensing result which does meet the Quality of Service requirement specified for the sensing service.

In certain representative embodiments, sensing entities are assigned to different service levels in advance of receiving a request for a sensing service. The system may then take the assigned service level into account when allocating sensing entities to groups in providing a sensing service using a multi-step sensing operation.

In certain representative embodiments, the sensing entities that are assigned to groups are updated. For example, the system may initiate a sensing operation for a group, detect that some sensing entities are not available for sensing operation, discover and select new sensing entities for the sensing operation, and assign the newly selected sensing entities to the group.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a reference model of a 5G/NextGen network, according to one or more embodiments;

FIG. 3A illustrates the use of a wireless network to detect the intrusion of pedestrians or animals on a highway according to one or more embodiments;

FIG. 3B illustrates the use of a wireless network to detect an intruding person or animal in the surroundings of a smart home according to one or more embodiments;

FIG. 4 is a table enumerating different sensing service categories for object detection and tracking according to one or more embodiments;

FIGS. 5A and 5B illustrate a hierarchical sensing operation with sensing operation group according to one or more embodiments;

FIGS. 6A and 6B illustrate a hierarchical sensing operation with sensing policy according to one or more embodiments;

FIG. 7 illustrates a sensing group member update according to one or more embodiments; and

FIG. 8 illustrates a method of performing a sensing operation according to one or more embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

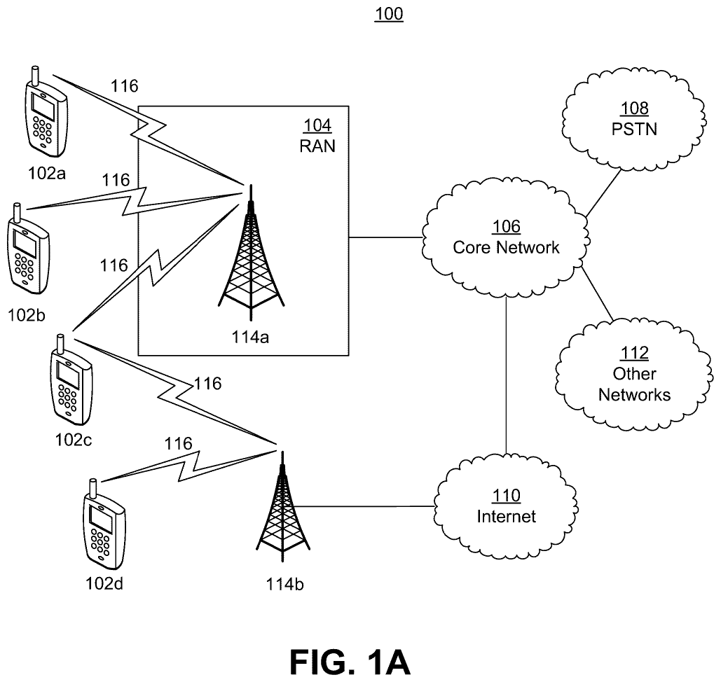

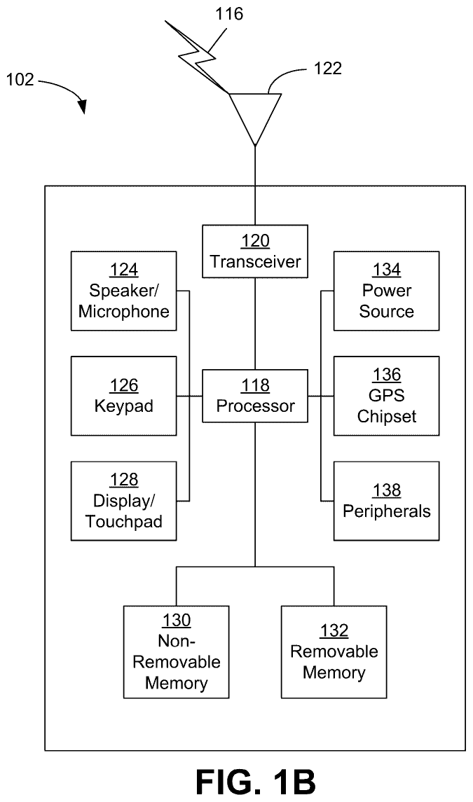

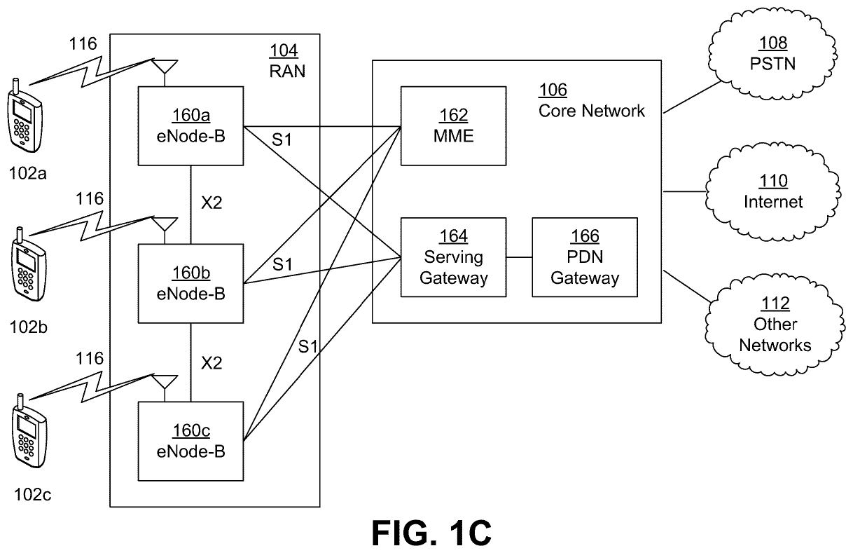

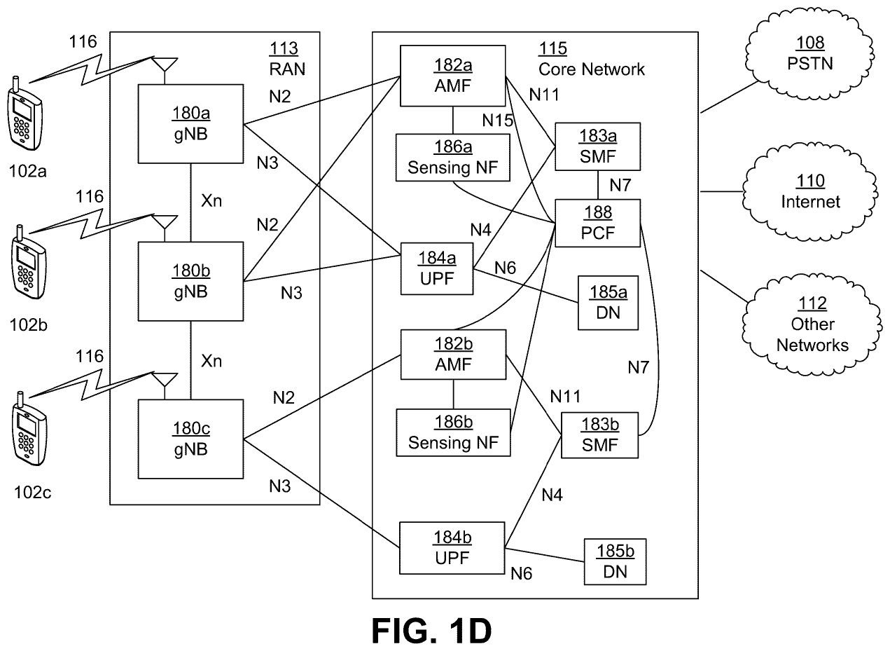

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. The CN 115 may further include a Policy Control Function (PCF) 188, and a Sensing Network Function 186a, 186b.

While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS (Network Access Stratum) signaling, mobility management, registration management, connection management, reachability management and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may manage sessions (including session establishment, modification and release) and control UP (User Plane) function. For example, the SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, packet inspection, traffic usage reporting, enforcing user plane policies, supporting multi-homed PDU sessions, handling user plane QoS, buffering downlink packets, providing mobility anchoring, and the like.

The PCF 188 may be connected to an AMF 182a, 182b via an N15 interface, and may be connected to an SMF 183a, 183b by an N7 interface. The Policy Control Function (PCF) may provide policies which control the operation of the network and the WTRUs (102a, 102b, 102c). The use of policies may provide the operator of the CN 115 with a mechanism for managing the operation of the network.

The Sensing NF 186a, 186b may provide a sensing function, which may be made available to external applications via a Network Exposure Function (NEF). Each Sensing NF 186a, 186b may have an operational link with an AMF 182a, and may have a direct or indirect (via the AMF 182a, 182b) operational link to the PCF 188.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

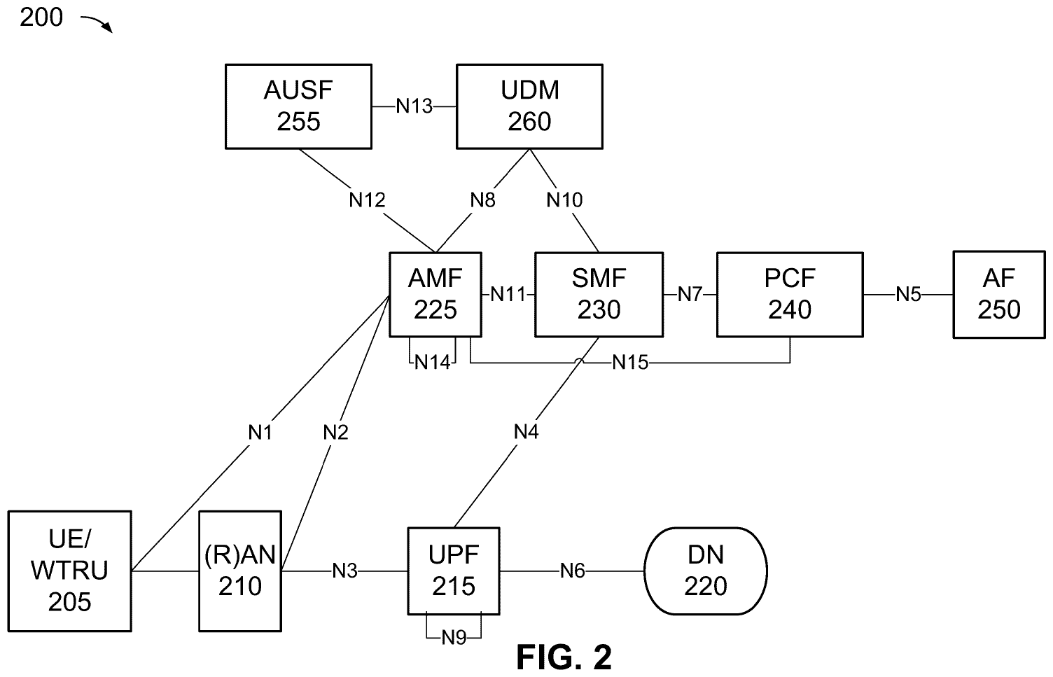

Depicted in FIG. 2 is a reference model 200 of a potential architecture of 5G or NextGen network. For example, the reference model 200 includes at least one of UE (WTRU) 205, (Radio) Access Network ((R)AN) 210, User Plane Function (UPF) 215, Data Network (DN) 220, Access and Mobility Management Function (AMF) 225, Session Management Function (SMF) 230, Policy Control Function (PCF) 240, Application Function (AF) 250, Authentication Server Function (AUSF) 255, Unified Data Management (UDM) 260, combinations of the same, or the like. Also, for example, one or more interfaces Nx therebetween are provided including at least one of: interface N1 between the UE/WTRU 205 and the AMF 225, interface N2 between the (R)AN 210 and the AMF 225, interface N3 between the (R)AN 210 and the UPF 215, interface N4 between the UPF 215 and the SMF 230, interface N5 between the PCF 240 and the AF 250, interface N6 between the UPF 215 and the DN 220, interface N7 between the SMF 230 and the PCF 240, interface N8 between the AMF 225 and the UDM 260, interface N9 between functions of the UPF 215, interface N10 between the SMF 230 and the UDM 260, interface N11 (Namf or Nsmf) between the AMF 225 and the SMF 230, interface N12 between the AMF 225 and the AUSF 255, interface N14 between functions of the AMF 225, interface N15 between the AMF 225 and the PCF 240, combinations of the same, or the like.

The (R)AN 210 refers to a(n) (radio) access network based on a 5G RAT or Evolved E-UTRA that connects to the NextGen core network. The AMF 225 includes at least one of the following functionalities: registration management, connection management, reachability management, mobility Management, combinations of the same, or the like. The SMF 230 includes at least one of the following functionalities: session management (e.g., including session establishment, modify and release, or the like), WTRU IP address allocation, selection and control of User Plane (UP) function, combinations of the same, or the like. The UPF 215 includes at least one of the following functionalities: packet routing and forwarding, packet inspection, traffic usage reporting, or the like.

A 5G system may be enhanced to provide an integrated sensing and communications system. Such a system may provide sensing services addressing different target verticals and applications, e.g. autonomous/assisted driving, V2X (Vehicle to Everything), UAVs (Unmanned Aerial Vehicles), 3D map reconstruction, smart city, smart home, factories, healthcare, maritime sector.

Providing a sensing service may involve a process of collecting sensing measurement data which is data collected about radio/wireless signals impacted (e.g. reflected, refracted, diffracted) by an object or environment of interest. Providing a sensing service may further involve deriving sensing results by processing sensing measurement data. An area may be defined for sensing, so called sensing service area location, which is an area with or without obstacles, in which the 5G system may provide sensing service with certain quality.

Other non-3GPP entities may also be involved in providing sensing services and their sensing measurement data may be provided to a 5GS using a standard protocol to an interface defined by the 5GS.

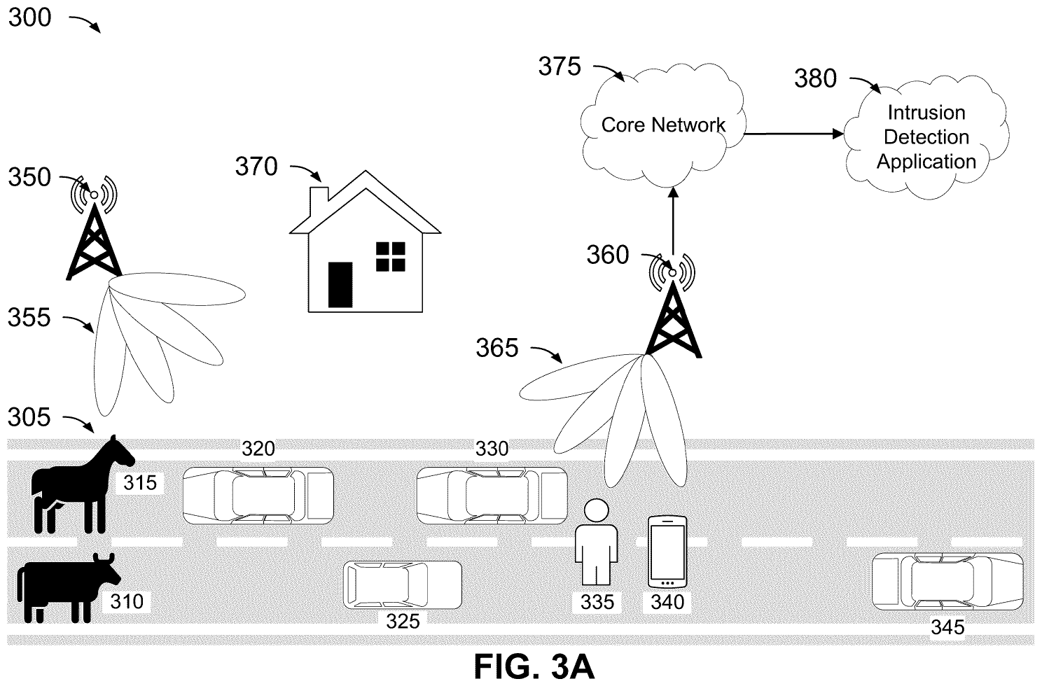

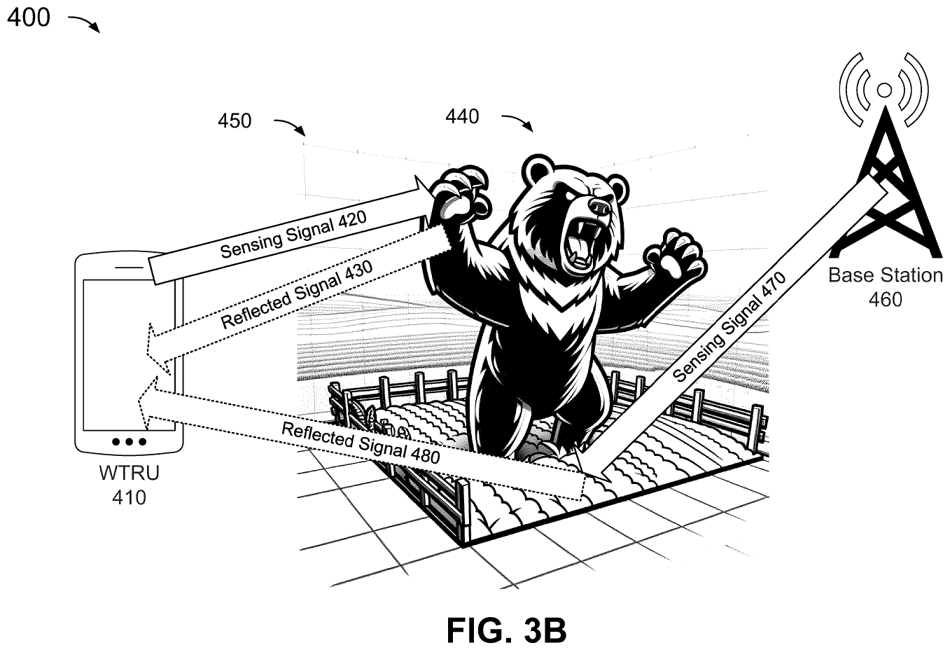

One use case for an integrated sensing and communication network may be object detection. For example, as illustrated in FIG. 3A, the intrusion of a pedestrian or animal on a highway may be detected. In another example, as illustrated in FIG. 3B, the intrusion of a human or animal into the surroundings of a smart home may be detected.

As shown in FIG. 3A, for example, in an outdoor environment 300, pedestrian and/or animal intrusion detection is provided. The environment 300 includes a highway 305 and a residential property 370 adjacent the highway 305. A base station 350 at a first location and a base station 360 at a second location emit beams 355 and 365, respectively. The beams 355 and 365 interact with the highway 305 and objects 310-345 on the highway 305 such as a first animal (e.g., cow) 310, a second animal (e.g., horse) 315, a first vehicle 320 traveling in a first direction (right-to-left on the page), a second vehicle 325 traveling in a second direction (left-to-right) opposite the first direction, a third vehicle 330 traveling in the first direction, a pedestrian 335 traveling in the first direction, the pedestrian 335 carrying a WTRU 340, and a fourth vehicle 345 traveling in the second direction. Information regarding the highway 305, the property 370, and the objects 310-345 is transmitted by the base stations (the base station 360 in this example) to a core network 375. The core network 375 transmits the information to an intrusion detection application 380. The intrusion detection application 380 is configured to sense, identify, and/or track the objects 310-345, for example, with respect to the base stations 350, 360 and/or one or more fixed points along the highway 305 and/or the property 370. The intrusion detection application 380 may be configured to differentiate between different types of vehicles (e.g., a compact vehicle 325 versus a large vehicle 345) or different types of objects (e.g., a horse 315 versus a human 335) and there corresponding locations, directions of movement, velocities, or the like.

As shown in FIG. 3B, for example, in an outdoor environment 400, intruder detection in surroundings 450 of a smart home is provided. The environment 400 includes a WTRU 410, an intruder (e.g., a bear) 440, and a base station 460. The WTRU 410 is configured to transmit a sensing signal 420, which, in this example, is incident on the intruder 440. The WTRU 410 is configured to receive a reflected signal 430, which, in this example, reflects the sensing signal 420 after incidence with the intruder 440. The base station 460 is configured to transmit a sensing signal 470, which, in this example, is incident on the surroundings (e.g., the ground) 450. The WTRU 410 is configured to receive a reflected signal 480, which, in this example, reflects the sensing signal 470 after incidence with the surroundings 450.

In the scenarios of FIGS. 3A and 3B, a base station (e.g., 350, 360, 460) and/or a WTRU (e.g., 340, 410) can detect the intrusion of an object (e.g., cow 310, vehicle 320, bear 440) into the sensing area of the base station by itself or by collaboration between the WTRU and the base station. The sensing measurement may be transferred to the core network 375 and further processed into a sensing result.

A sensing service provided by an integrated sensing and communication (ISAC) network may offer, for each of a plurality of sensing scenarios (e.g. object detection, tracking, motion detection, etc.), different sensing service categories, each category having its own QoS (Quality of Service) requirements (e.g., resolution in location, resolution in velocity, accuracy, conformance rate, etc.). One sensing scenario may be object detection and tracking. The QoS requirements specified for each category may include one or more of a confidence level of a sensing result, an accuracy of an object position estimate (e.g., to achieve a target confidence level), an accuracy of object velocity estimate, a range resolution or velocity resolution, a maximum sensing latency, a sensing refresh rate, a missed detection probability, and a false alarm probability.

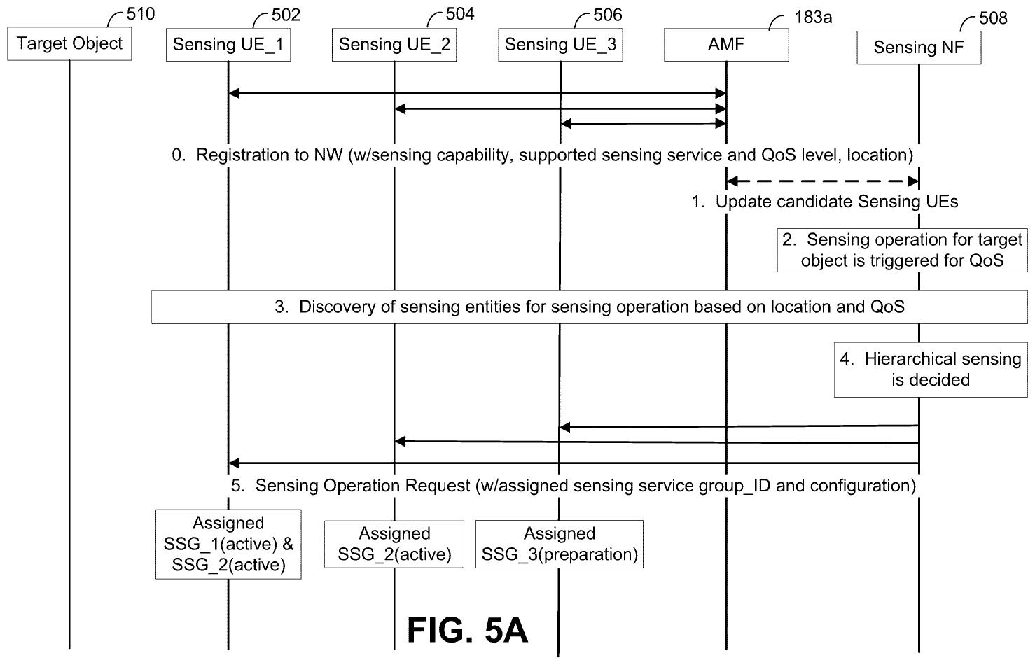

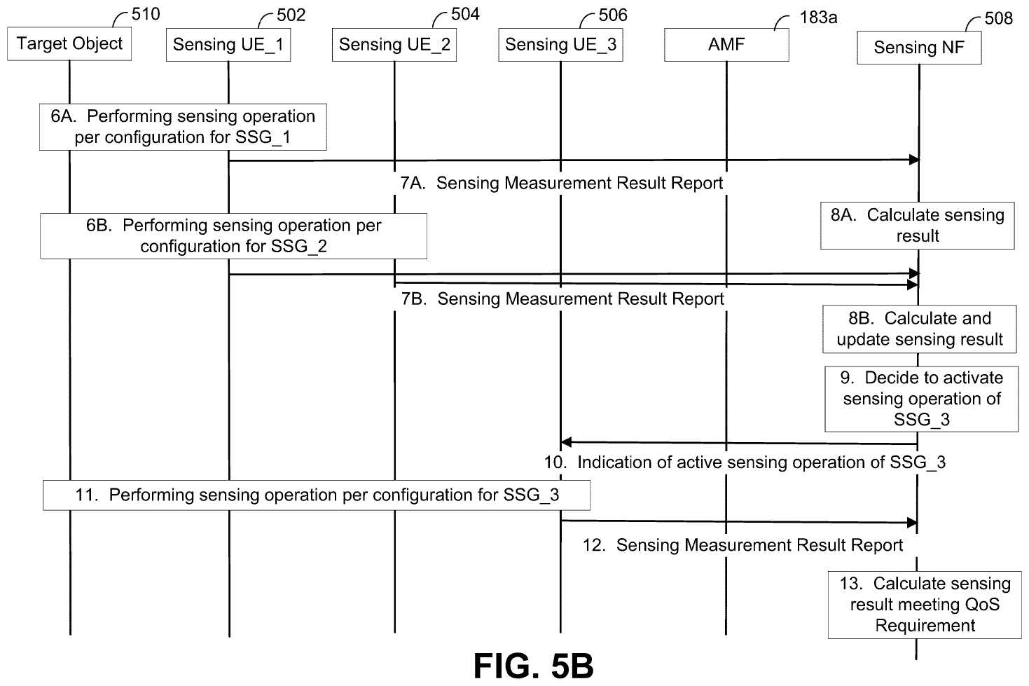

FIG. 5 show a table of key performance indicators (KPIs) for various object detection and tracking scenarios. The table includes details on confidence levels, accuracy of positioning and velocity estimates, sensing resolution, maximum sensing service latency, refreshing rate, missed detection, and false alarm rates. The scenarios vary in terms of the precision required for horizontal and vertical positioning, velocity estimates, and the specific needs for different applications such as public safety, pedestrian tracking, and short-range radar.

Each of the accuracy of object position estimate, object velocity estimate, range revolution and velocity resolution may be given separately for vertical and horizontal dimensions.

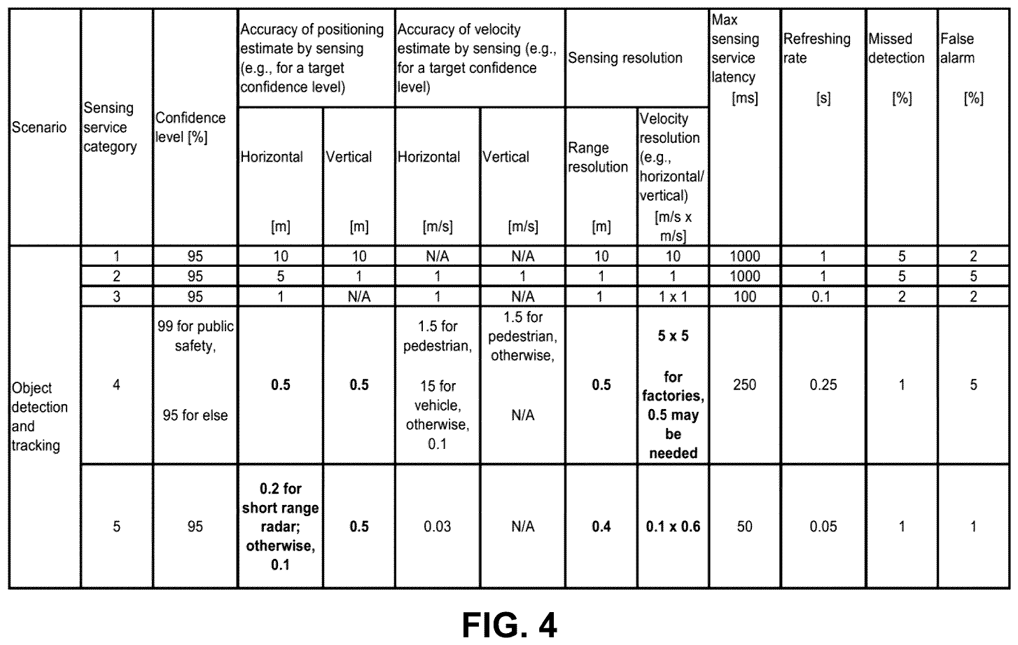

By way of example, for the sensing scenario of object detection and tracking, five different sets of QoS requirements may be provided (in other words, five different QoS levels might be specified). In the example illustrated in FIG. 4, the second to sixth rows of the table correspond to first to fifth sets of QoS requirements. In general, the QoS requirements become higher in the lower rows of the table. For example, the required accuracy of positioning varies from 0.1 m in relation to the highest QoS level (sixth row in the table), to 10 m in relation to the first QoS level (second row in the table). Similarly, the service latency varies from 1 second for the lowest QoS level to 50 milliseconds for the highest QoS level.

Turning now to more detail on the KPIs for the different scenarios, in Scenario 1, the confidence level is 95%. The accuracy of the positioning estimate is 10 meters horizontally and 10 meters vertically. The accuracy of the velocity estimate is not applicable. The sensing resolution includes a range resolution of 10 meters and a velocity resolution of 10 meters per second. The maximum sensing service latency is 1000 milliseconds, with a refreshing rate of 1 second. The missed detection rate is 5%, and the false alarm rate is 2%.

In Scenario 2, the confidence level is 95%. The accuracy of the positioning estimate is 5 meters horizontally and 1 meter vertically. The accuracy of the velocity estimate is 1 meter per second both horizontally and vertically. The sensing resolution includes a range resolution of 1 meter and a velocity resolution of 1 meter per second. The maximum sensing service latency is 1000 milliseconds, with a refreshing rate of 1 second. The missed detection rate is 5%, and the false alarm rate is 5%.

In Scenario 3, the confidence level is 95%. The accuracy of the positioning estimate is 1 meter horizontally and not applicable vertically. The accuracy of the velocity estimate is 1 meter per second horizontally and not applicable vertically. The sensing resolution includes a range resolution of 1 meter and a velocity resolution of 1 meter per second by 1 meter per second. The maximum sensing service latency is 100 milliseconds, with a refreshing rate of 0.1 second. The missed detection rate is 2%, and the false alarm rate is 2%.

In Scenario 4, the confidence level is 99% for public safety and 95% for others. The accuracy of the positioning estimate is 0.5 meters both horizontally and vertically. The accuracy of the velocity estimate is 1.5 meters per second for pedestrians, 15 meters per second for vehicles, and 0.1 meters per second otherwise horizontally, and 1.5 meters per second for pedestrians and not applicable otherwise vertically. The sensing resolution includes a range resolution of 0.5 meters and a velocity resolution of 5 meters per second by 5 meters per second, with 0.5 meters per second needed for factories. The maximum sensing service latency is 250 milliseconds, with a refreshing rate of 0.25 second. The missed detection rate is 1%, and the false alarm rate is 5%.

In Scenario 5, the confidence level is 95%. The accuracy of the positioning estimate is 0.2 meters for short-range radar and 0.1 meters otherwise horizontally, and 0.5 meters vertically. The accuracy of the velocity estimate is 0.03 meters per second horizontally and not applicable vertically. The sensing resolution includes a range resolution of 0.4 meters and a velocity resolution of 0.1 meters per second by 0.6 meters per second. The maximum sensing service latency is 50 milliseconds, with a refreshing rate of 0.05 second. The missed detection rate is 1%, and the false alarm rate is 1%.

In some scenarios, it would be beneficial to provide a sensing service with granularity of less than 1 meter level. For example, for object detection and tracking, detection and tracking of human, animal and UAV in indoor and outdoor environment may require sensing service with accuracy of 0.5×0.5 square meter, resolution of 0.5 m. As another example, for motion monitoring, human hand gestures may require sensing service with accuracy of 0.2×0.2 square meter, and resolution of 0.375 m.

In order to support better sensing QoS (e.g., high resolution and higher accuracy), more frequent measurement of sensing signals from more sensing entities may be provided.

Additionally, for better sensing result with higher sensing QoS requirements, fusing different sensing data, multi-modal sensing (BS monostatic, BS bistatic vs WTRU and BS collaboration) may also be used.

All these considerations may require more bandwidth and higher energy consumption of system as they bring more sensing entities into more frequent involvement.

There is a need to provide ISAC operation with minimal number of sensing entities involved while satisfying QoS requirement(s). There is also a need to provide an energy efficient sensing operation.

Different sensing use cases may require different levels of sensing service with different QoS requirements.

For example, in object detection in a smart factory for safety monitoring, when a mobile object is in a static condition (e.g. in parking state), a minimum number of sensing entities may be required to sense, however when the mobile object is moving, an additional number of sensing entities may be involved to detect movement in high accuracy and to avoid collision with human workers.

In another example, in UAV tracking, a two-step sensing strategy may be used. At first, a small number of sensing entities may be involved to detect the presence of UAV at the expected area (BS2, UE1, UE2, and UE3 may be involved for sensing operation among them). After UAV is detected, more sensing entities may be involved to detect movement of UAV in higher granularity (BS1, UE3, UE4, and UE5 may be additionally involved for sensing operation and to detect movement in horizontal direction and vertical direction).

In use cases such as these, a sensing NF (Network Function) may apply a hierarchical sensing strategy. Hierarchical sensing strategy may mean multi-step sensing operation.

For example, a sensing operation may utilize light sensing operation at initial stage (i.e., sensing operation with small number of sensing entities for low QoS requirement) and extend to more complex sensing operation for satisfying higher QoS requirement at a later stage (which may need more sensing entities involved or more frequent sensing operation).

As another example, a sensing operation may utilize the minimum number of sensing entities for initial sensing operation with QoS requirement. And when the sensing result does not satisfy some part of QoS requirement, more sensing entities may be involved in the sensing operation and/or more frequent sensing operation may be fulfilled.

For the hierarchical sensing strategy, after discovery of sensing entities for sensing with a QoS requirement, a sensing NF may assign a sensing group to each of a plurality of selected sensing entities. Different sensing groups have different configuration for sensing operation among the entities belonging to the same sensing group. One sensing entity may belong to multiple sensing groups. Some sensing groups may activate sensing operation when a sensing NF indicates to start a sensing operation.

By assigning multiple sensing groups for a sensing service, a system may provide more energy efficient sensing operation by adjusting resource and energy for sensing operation per sensing group. And based on a sensing result, a system may bring more resource for sensing operation.

In certain representative embodiments, a hierarchical energy efficient sensing operation may involve a sensing NF receiving a request for sensing operation with QoS requirement, discovering and selecting sensing entities for sensing operation with QoS requirement, determining to apply hierarchical sensing strategy (in some embodiments, the hierarchical sensing strategy might be applied by default), assigning a sensing entity to one or more sensing operation group(s) and providing sensing configuration information for each sensing operation group. The hierarchical energy efficient sensing operation may further involve the sensing NF activating sensing operation for some sensing operation group for the requested sensing service with QoS requirement.

In certain representative embodiments, a hierarchical energy efficient sensing operation may involve a WTRU receiving a sensing operation request from a sensing NF including assigned sensing operation group(s), receiving sensing configuration information for each sensing operation group, waiting for indication from sensing NF for activation of sensing operation for sensing operation group(s), and performing sensing operation as indicated by sensing NF when the WTRU is in an activated sensing operation group.

FIGS. 5A and 5B illustrate a hierarchical energy efficient sensing operation according to one or more embodiments. The hierarchical energy efficient sensing operation may involve actions performed by network entities, for example, sensing UE's 502, 504, and 506, AMF 182a, and sensing NF 508 to detect and/or track target object 510. In some embodiments, the sensing UEs 502, 504, and 506 (also referred to as sensing entities) may each correspond to a WTRU 102 of FIGS. 1A-1D. In a step 0, each of sensing entities 502, 504, 506 may register their capability as sensing entities and supported sensing services. The sensing entities 502, 504, 506 may include supported QoS level for the supported sensing service and their location. Sensing entities 502, 504, 506 may also be preconfigured with a “sensing service area identification” which represents the location of the sensing entity and the area that the sensing entity is monitoring, such as a building.

If the sensing entity is a UE, it may report its sensing capability via a NAS message (e.g. Registration or Registration Update); if the sensing entity is a Base Station, it may report its sensing capability via a N2 procedure/message.

After receiving capability registration of sensing entities, the AMF 183a may update (Step 1) the list of sensing entities at AMF's service area (e.g., at tracking area level) to sensing NF 508. The list of sensing entities may also be per “sensing service area” when sensing service area information is provided to AMF 182a. In another example embodiment, AMF 182a may update the list of sensing entities per cell area which belong to AMF's service area.

The Sensing NF 508 may be requested (Step 2) to perform a sensing operation for a target object 510 with a requested QoS level. The sensing operation may be requested to be performed at a certain target sensing service area.

The sensing NF 508 may discover (Step 3) sensing entities based on the requested sensing service with QoS level. The sensing NF may consider requested area for sensing (as received in step 2).

The sensing NF 508 may request the AMF 182a which serves the requested area to provide a list of sensing entities at the AMF's service area or the target sensing service area and get response with list of sensing entities.

If sensing NF 508 has previously been informed about the list of sensing entities by AMF 182a (e.g. in step 1), the sensing NF 508 may consider the listed sensing entities as candidate sensing entities for the requested sensing service.

The sensing NF 508 may decide (Step 4) to apply a hierarchical sensing strategy for the requested sensing service. For example, the sensing NF 508 may decide to initiate sensing operation with a minimal number of sensing entities as sensing operation group(s) for satisfying QoS of requested sensing service in order to minimize resource overhead or energy consumption. For example, a minimal number of sensing entities may be preconfigured, updated based on history of relevant sensing service or input from network analytics service, or the like. And if QoS is not satisfied with the operation, the sensing NF 508 may involve more sensing entities assigned to other sensing operation group(s) to satisfy the QoS requirement of the requested sensing service.

As another example, the hierarchical sensing strategy may be different per use case. For the tracking of UAVs, the first sensing operation may aim to detect a UAV at the interested area. Therefore, the sensing NF 508 may decide to initiate sensing operation with a number of sensing entities as sensing operation group(s) to detect the UAV at the interested area. After detecting the UAV, the sensing NF 508 may decide to involve another sensing operation group to sense direction of movement of the UAV and track the UAV along a path of interest.

Having adopted a hierarchical sensing strategy, the sensing NF 508 may determine a number of sensing operation groups for providing the requested sensing service and determine which sensing entities are to be assigned to which sensing operation group(s).

The sensing NF 508 may assign (Step 5) one or multiple sensing operation groups (SSG(s)) to each selected sensing entities (e.g., BSs and UEs).

Different sensing operation groups (i.e., SSGs) may be configured with different sensing configuration information for sensing operations with different QoS requirements (e.g., granularity, accuracy, latency, etc.). Sensing configuration information may include sensing mechanism, measuring periodicity, sensing service area, etc.

Different sensing operation groups may have different sensing operation periodicity. Sensing operation periodicity may indicate how often sensing operation (sensing signal transmission and/or sensing signal measurement) happens and the interval between from one sensing operation and the next sensing operation).

One or more sensing operation groups may be configured to activate sensing operation on demand from the sensing NF 508.

For example, as can be seen in FIG. 5A, sensing UE_1 502 may be assigned to sensing operation group_1 (i.e., SSG_1) and sensing operation group_2 (i.e., SSG_2), sensing UE_2 504 may be assigned to sensing operation group_2, and sensing UE_3 506 may be assigned to sensing operation group_3 (i.e., SSG_3) which is configured to wait until sensing NF 508 activates sensing operation.

Turning now to FIG. 5B (which represents a continuation of the process seen in FIG. 5A), sensing entities (e.g. sensing entity 502) in the active sensing operation groups (e.g. SSG_1) may perform a sensing operation (step 6A) according to the configuration per sensing operation group provided by the sensing NF 508.

The sensing entities (e.g. sensing entity 502) in the active sensing operation groups (e.g. SSG_1) may report (Step 7A) a sensing measurement result to sensing NF 508.

The sensing NF 508 may calculate (step 8A) a sensing result based on reported sensing measurement result.

Thereafter, sensing entities (e.g. sensing entities 502, 504) in the active sensing operation groups (e.g. SSG_2) may perform a sensing operation (step 6B) according to the configuration per sensing operation group provided by the sensing NF 508.

The sensing entities (e.g. sensing entity 502, 504) in the active sensing operation groups (e.g. SSG_2) may report (Step 7B) a sensing measurement result to sensing NF 508.

The sensing NF 508 may calculate and update (step 8B) a sensing result based on reported sensing measurement result.

Based on sensing result, sensing NF 508 may decide (Step 9) to activate sensing operation of another sensing operation group (for example to get better sensing result in terms of granularity, or conformance rate).

Having decided to activate sensing operation of another sensing operation group, the sensing NF 508 may activate (Step 10) sensing operation of another sensing operation group (here, sensing operation group_3).

Sensing operation group_3 may start sensing operation (step 11) as instructed (Step 10) by the sensing NF 508 and report (Step 12) the sensing measurement result to the sensing NF 508.

Sensing NF may then calculate (Step 13) a sensing result meeting the QoS requirement from the sensing measurement reports from sensing operation group_1, sensing operation group_2 and sensing operation group_3.

As another embodiment, sensing NF 508 may decide hierarchical sensing as a different strategy. For example, sensing NF 508 may decide to activate sensing operation of SSG_1, SSG_2, SSG_3 at starting. And based on sensing result, sensing NF may decide to deactivate sensing operation of SSG_2 and/or SSG_3 for better energy efficiency while supporting QoS requirements of requested sensing service.

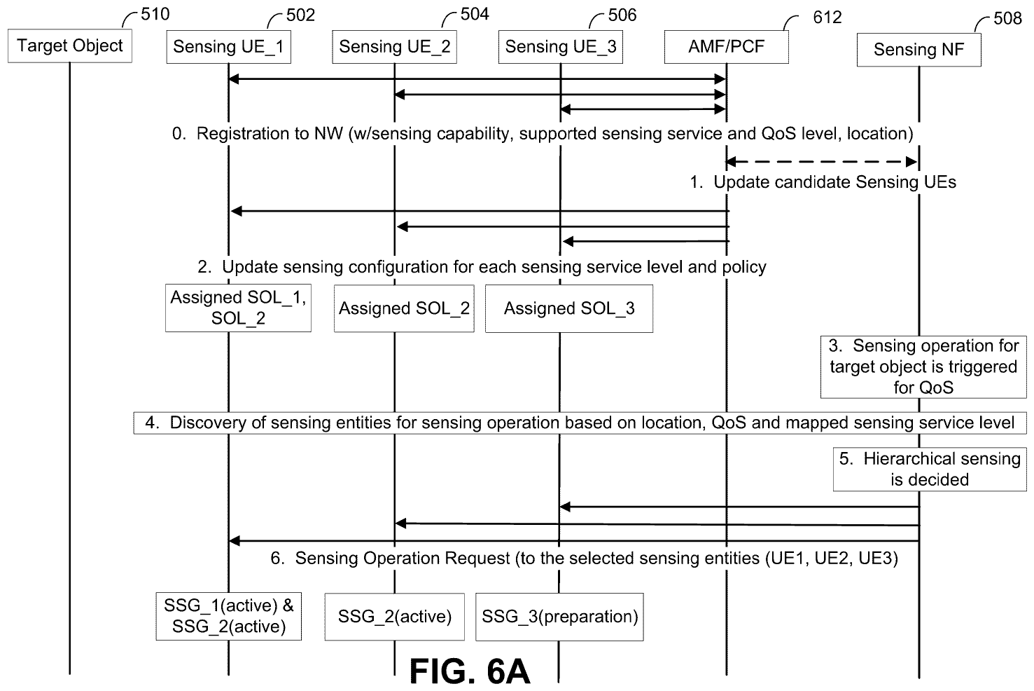

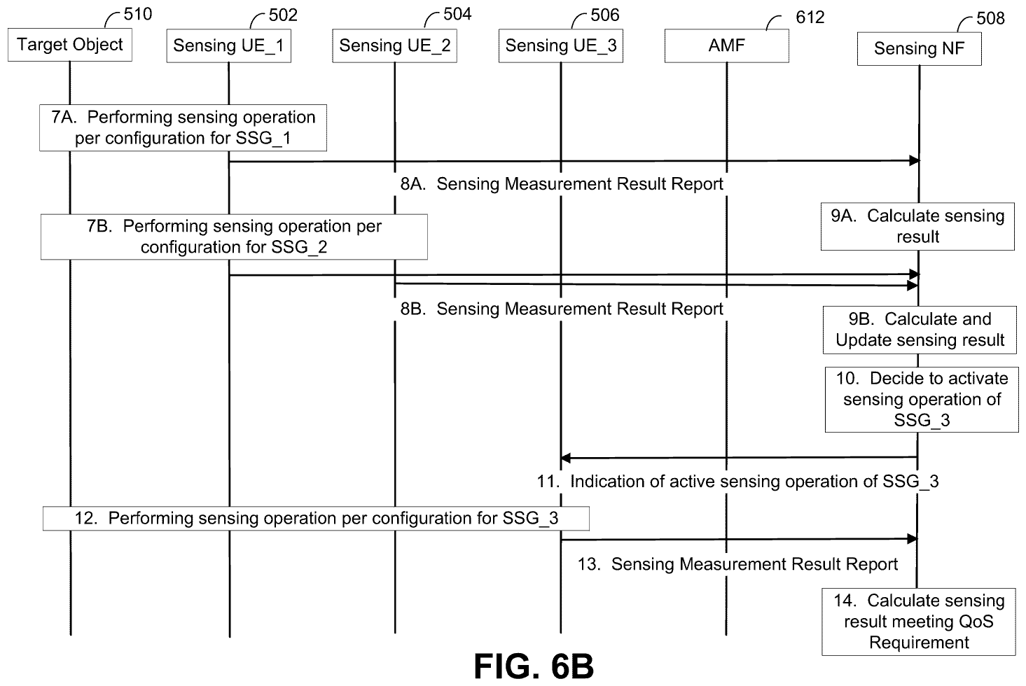

FIGS. 6A and 6B illustrate a hierarchical energy efficient sensing operation according to one or more embodiments. The hierarchical energy efficient sensing operation may involve actions performed by similar network entities to those described in relation to FIGS. 5A and 5B above, though in the present embodiment the AMF is replaced with an AMF/PCF 612 which combines a PCF (Policy Control Function) with AMF 182a.

Each of sensing entities 502, 504, 506 (also referred to as sensing UE_1 502, sensing UE_2 504, and sensing UE_3 506 in FIGS. 6A and 6B) may register (Step 0) their capability as sensing entities and supported sensing service with supported QoS level for the supported sensing service and location of sensing entity 502, 504, 506. Based on the sensing capability of sensing entities 502, 504, 506, the system may assign each sensing capable UE to a sensing operation level.

After receiving capability registration of sensing entities, the AMF/PCF 612 may update (Step 1) the list of sensing entities at AMF's service area to the sensing NF 508.

The system may provide sensing entities 502, 504, 506 with a sensing policy to assign sensing operation level(s) and configure sensing operation for the assigned sensing operation(s).

For example, in FIG. 6A, sensing UE_1 502 is assigned to sensing operation level_1 (i.e., SOL_1) and sensing operation group_2 (i.e., SOL_2) and configured with corresponding sensing policy for each sensing operation level. In example embodiments, sensing policy may include sensing mechanism, measuring periodicity, sensing service area, etc.

The Sensing NF 508 may be requested (Step 3) to perform a sensing operation for a target object 510 with a requested QoS level. The sensing operation may be requested to be performed at a certain area.

The sensing NF 508 may discover (Step 4) sensing entities based on sensing operation level(s) corresponding to the requested sensing service with QoS level and sensing service area to cover the area requested in step 3.

The sensing NF 508 may request the AMF 182a which serves the requested area to provide a list of sensing UEs at AMF's service area and get a response listing sensing entities with assigned sensing operation level.

If the sensing NF 508 has previously been informed about the list of sensing entities by AMF 182a (e.g. in step 1), the sensing NF may consider the listed sensing entities as candidate sensing entities for the requested sensing service based on the sensing operation level.

The sensing NF 508 may decide (Step 5) to apply a hierarchical sensing strategy for the requested sensing service and select sensing operation level(s) for the requested sensing service.

The sensing NF 508 may select sensing entities from the selected sensing operation levels (e.g., BSs and UEs) and assign the selected sensing entities to some sensing operation group(s).

For example, in FIG. 6A, Sensing UE_1 502 is assigned to SSG_1 which is associated to SOL_1. Sensing UE_1 502 and Sensing UE_2 504 are assigned to SSG_2 which is associated to SOL_2. Sensing UE_3 506 is assigned to SSG_3 which is associated to SOL_3.

For example, SSG_1 may perform sensing operation at every 10 msec and SSG_2 may perform sensing operation at every 5 msec. And SSG_3 may perform sensing operation at every 5 msec if it is indicated to activate. In this example, Sensing NF 508 may try to minimize the resource for sensing operation by reducing the number of sensing entities for higher frequency sensing operation. (at every 10 msec, SSG_1 and SSG_2, but at every 5 msec, only SSG_2 may work for sensing.) After that, if needed, sensing NF may decide to activate more entities for higher frequency sensing operation (SSG_3).

The sensing NF 508 may send (Step 6) sensing operation requests to the selected sensing entities. The sensing NF 508 may include assigned sensing operation groups with associated sensing operation level and an indication for each sensing operation group to activate sensing operation or to wait for another indication to activate sensing operation.

For example, in FIG. 6A, sensing operation group_1 associated to sensing operation level_1 and sensing operation group_2 associated to sensing operation level_2 are indicated to activate sensing operation as configured at sensing policy. However, sensing operation group_3 associated to sensing operation level_3 is indicated to wait until the sensing NF 508 activates sensing operation.

Turning now to FIG. 6B (which represents a continuation of the process seen in FIG. 6A), sensing entities (e.g., sensing UE_1 502) may perform a sensing operation (step 7A) according to the sensing policy of the associated sensing operation level for the assigned sensing operation groups.

The sensing operation group may report (Step 8A) a sensing measurement result to sensing NF 508.

The sensing NF 508 may calculate (Step 9A) a sensing result based on reported sensing measurement result.

Thereafter, sensing entities (e.g. sensing UEs 502, 504) in the sensing operation group associated to sensing operation level 2 (e.g. SSG_2) may perform a sensing operation (step 7B) according to the sensing policy of the associated sensing operation level for the assigned sensing operation groups.

The sensing entities (e.g. sensing entities 502, 504) in the sensing operation group (e.g. SSG_2) may report (Step 8B) a sensing measurement result to sensing NF 508.

The sensing NF 508 may calculate and update (step 9B) a sensing result based on reported sensing measurement result.

Based on sensing result, sensing NF 508 may decide (Step 10) to activate sensing operation of another sensing operation group (for example to get better sensing result in terms of granularity, or conformance rate).

Having decided to activate sensing operation of another sensing operation group, the sensing NF 508 may activate (Step 11) sensing operation of another sensing operation group (here, sensing operation group_3).

Sensing operation group_3 may start sensing operation (step 12) as instructed (Step 11) by the sensing NF 508 based on sensing policy of the associated sensing operation level and report (Step 13) the sensing measurement result to the sensing NF 508.

The sensing NF 508 may then calculate (Step 14) a sensing result meeting the QoS requirement from the sensing measurement reports from sensing operation group_1 (received in step 8A), sensing operation group_2 (received in step 8B) and sensing operation group_3 (received in step 13).

In certain representative embodiments, a sensing group update may involve a sensing NF initiating sensing operation at sensing entities for some sensing operation group, detecting some sensing entities are not available for sensing operation, discovering and selecting new sensing entities for the sensing operation, assigning newly selected sensing entities to sensing operation group, and informing sensing operation group of updated sensing entities.

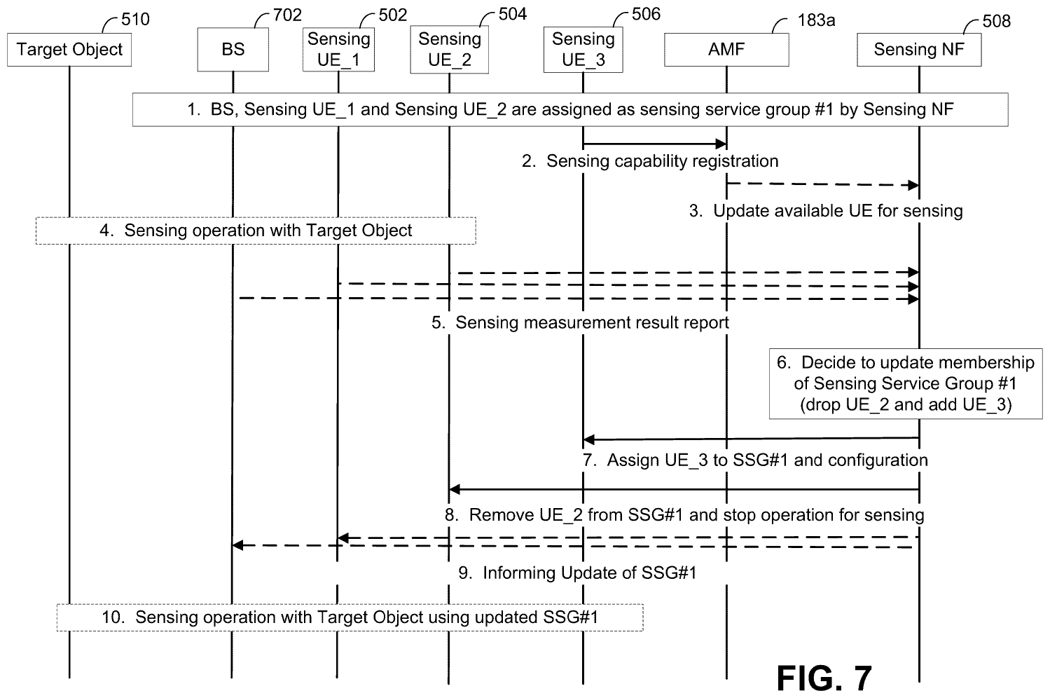

FIG. 7 illustrates a sensing group membership update according to one or more embodiments. The network entities involved may correspond to those seen in FIGS. 5A and 5B, though in the present example, the sensing entities further comprise a BS (base station) 702.

Sensing NF 508 may decide a sensing group member update based on sensing entities' mobility, the radio environment at the sensing location (e.g. channel situation, weather), so that proper sensing entities for some sensing service may be properly handled at different situation per time, environment.

When decided, the sensing member update procedure illustrated in FIG. 7 may be performed.

Additionally, update of sensing group membership may be informed to other sensing entities. For example, when BS 702 is informed of the new sensing entities, physical layer resource may be updated for proper sensing operation.

Turning now to FIG. 7, sensing NF 508 may assign one or multiple sensing operation groups to each selected sensing entities with sensing configuration information for sensing operation at the sensing operation group. For example, in FIG. 7, BS 702, sensing UE_1, sensing UE-2 are assigned as sensing service group_1. In certain representative embodiments, sensing configuration information may include sensing mechanism, measuring periodicity, sensing service area, etc.

A UE (here, sensing UE_3 506) may register (Step 2) with the AMF 182a with its sensing capability as sensing entities and supported sensing service. Optionally, sensing UE_3 506 may include supported QoS level for the supported sensing service and location of sensing entity.

After receiving capability registration of sensing entities, AMF 182a may update (Step 3) the list of sensing entities at AMF's service area including sensing UE_3 506 to sensing NF 508.

Sensing entities 502, 504, 702 may perform (Step 4) sensing operation according to the configuration per sensing operation group sent by sensing NF 508 (at step 1).

Sensing operation group may report (Step 5) sensing measurement result to sensing NF 508.

Sensing NF 508 may calculate a sensing result based on reported sensing measurement result. Based on sensing result, sensing NF 508 may decide (Step 6) to update member of sensing service group (here group #1) (e.g., because of poor sensing measurement report or no report from sensing UE_2 504, detection of movement of sensing UE_2 504 outside sensing service area, etc.). When a sensing service group is updated, the assignment of sensing entities to the sensing service group may be adjusted (e.g., one or more sensing entities is added and/or one or more sensing entities is removed).

Sensing NF 508 may discover new sensing entity to join sensing service group_1 based on supported sensing service and supported QoS level (here, sensing UE_3 506 is selected).

When there is any list of available sensing entities for sensing (e.g., provided by AMF 182a at step 3), it may be considered as a candidate list.

Sensing NF 508 may assign (Step 7) sensing UE_3 506 to sensing operation group_1 and provide sensing configuration information for sensing operation at sensing operation group_1.

Sensing NF 508 may inform (Step 8) sensing UE_2 504 to be removed from sensing operation group_1 and sensing UE_2 504 may be released from sensing operation of sensing operation group_1.

Sensing NF 508 may inform (Step 9) sensing operation group_1 of updated sensing member (e.g., sensing UE_2 504 is removed and sensing UE_3 506 is added).

Sensing entities group_1 may continue (Step 10) sensing operation with updated sensing member.

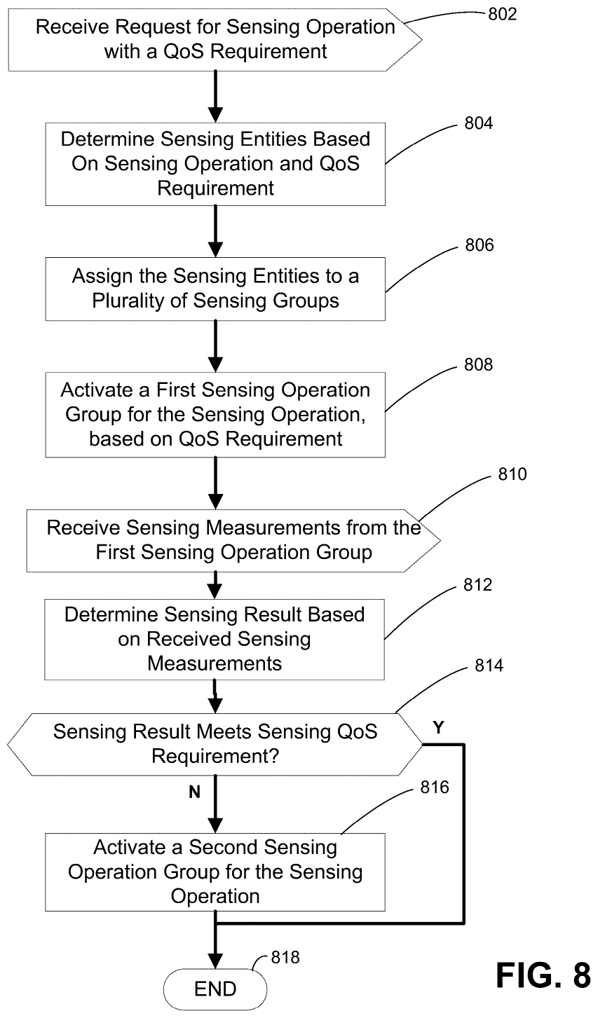

FIG. 8 illustrates a method of providing a sensing result which may be performed by a sensing network function (e.g., sensing NF 508). The method may be triggered by the receipt 802 of a request for a sensing operation, the request being indicative of a location of the sensing operation and a QoS requirement for the sensing operation. In some embodiments, the step 802 corresponds to step 2 in FIG. 5A. The sensing network function may determine 804 sensing entities for use in the sensing operation, based on the indicated location of the sensing operation and the QoS requirement for the sensing operation found in the request. In some embodiments, the step 804 corresponds to step 3 of FIG. 5A.

The sensing network function may assign 806 the sensing entities to a plurality of sensing operation groups, wherein each of the sensing operation groups has a respective (e.g. different) sensing configuration and comprises at least one of the sensing entities. The step 806 may be a precursor to the sending of the message in step 5 of FIG. 5A (that message indicating to the recipient sensing entity which Group_ID(s) the sensing entity has been assigned to). Having assigned the sensing entities to sensing groups, the network function may activate 808 a first sensing operation group of the plurality of sensing operation groups for the sensing operation, based on the QoS requirement for the sensing operation (e.g., this may correspond to the activation of steps 6A and 6B in FIG. 5A and the activation request may be included in step 5 of FIG. 5A). The sensing network function may then receive 810 sensing measurements from the first sensing operation group (e.g., corresponding to steps 7A and 7B of FIG. 5B), and determine 812 a sensing result based on the sensing measurements received from the first sensing operation group. Determining a sensing result may comprise calculating a sensing result in one or more embodiments. The step 812 may correspond to step 8A and/or 8B of FIG. 5B. The sensing result may then be compared 814 to the sensing QoS requirement received in the request for the sensing operation, and if the sensing QoS requirement is not met (which may correspond to decision step 9 in FIG. 5B), the sensing network function may activate 816 a second sensing operation group of the plurality of sensing operation groups (e.g., which may corresponds to the activation of step 10 in FIG. 5B).

It will be understood that while the method of FIG. 8 has been described above as corresponding to, for example, steps of FIGS. 5A and 5B, the method may also correspond to steps of FIGS. 6A and 6B. For example, the steps of the method of FIG. 8 may correspond to steps 3, 4, 6, 8A, 9A, 10, and 11 of FIGS. 6A and 6B.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by one or more processors of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method for wireless communications, the method comprising:
receiving a request for a sensing operation, the request being indicative of a location of the sensing operation and a Quality of Service (QoS) requirement for the sensing operation;
determining sensing entities for use in the sensing operation, wherein the determination is based on the indicated location of the sensing operation and the QoS requirement for the sensing operation;
assigning the sensing entities to a plurality of sensing operation groups, wherein each of the sensing operation groups has a respective sensing configuration and comprises at least one of the sensing entities;
activating a first sensing operation group of the plurality of sensing operation groups for the sensing operation based on the QoS requirement for the sensing operation;
receiving sensing measurements from the first sensing operation group;
determining a sensing result based on the sensing measurements received from the first sensing operation group; and
activating a second sensing operation group of the plurality of sensing operation groups based on the determined sensing result not meeting the QoS requirement.

2. The method according to claim 1 further comprising:
receiving sensing measurements from the second sensing operation group; and
determining an updated sensing result based on the sensing measurements received from the first sensing operation group and the sensing measurements received from the second sensing operation group.

3. The method according to claim 1 wherein assigning the sensing entities to the plurality of sensing operation groups comprises assigning a number of sensing entities to the first sensing operation group based on the QoS requirement.

4. The method according to claim 1 wherein determining the sensing entities based on the indicated location of the sensing operation comprises receiving a list of sensing entities from an access and mobility management function (AMF) having a service area which comprises the indicated location.

5. The method according to claim 1 wherein the sensing configuration comprises one or more of sensing mechanism information, sensing operation timing control information, or sensing service area information.

6. The method of claim 5 wherein the sensing operation timing control information comprises sensing operation periodicity information.

7. The method of claim 5 wherein the sensing operation timing control information comprises an indication that the sensing operation is to be performed on demand from a sensing network function.

8. The method of claim 1 wherein the determination of sensing entities for use in the sensing operation is further based on a sensing service level assigned to each sensing entity.

9. The method of claim 1 further comprising adjusting the assignment of sensing entities to the first sensing operation group based on the received sensing measurements.

10. The method of claim 1 further comprising adjusting the assignment of sensing entities to the first sensing operation group based on a radio environment in the location for the sensing operation.

11. A system implementing one or more network functions of a core network of a wireless network, wherein the system comprises:
one or more processors configured to:
receive a request for a sensing operation, the request being indicative of a location of the sensing operation and a Quality of Service (QoS) requirement for the sensing operation;
determine sensing entities for use in the sensing operation, wherein the determination is based on the indicated location of the sensing operation and the QoS requirement for the sensing operation;
assign the sensing entities to a plurality of sensing operation groups, wherein each of the sensing operation groups has a respective sensing configuration and comprises at least one of the sensing entities;
activate a first sensing operation group of the plurality of sensing operation groups for the sensing operation based on the QoS requirement for the sensing operation;
receive sensing measurements from the first sensing operation group;
determine a sensing result based on the sensing measurements received from the first sensing operation group; and
activate a second sensing operation group of the plurality of sensing operation groups based on the determined sensing result not meeting the QoS requirement.

12. The system of claim 11 wherein the one or more network functions comprises a sensing network function, and wherein the system is further configured to:
receive sensing measurements from the second sensing operation group; and
determine an updated sensing result based on the sensing measurements received from the first sensing operation group and the sensing measurements received from the second sensing operation group.

13. The system of claim 11 wherein assigning the sensing entities to the plurality of sensing operation groups comprises assigning a number of sensing entities to the first sensing operation group based on the QoS requirement.

14. The system of claim 11, wherein determining the sensing entities based the indicated location of the sensing operation comprises receiving a list of sensing entities from an access and mobility management function (AMF) having a service area which comprises the indicated location.

15. The system of claim 11, wherein the sensing configuration comprises one or more of sensing mechanism information, sensing operation timing control information, or sensing service area information.

16. The system of claim 15 wherein the sensing operation timing control information comprises sensing operation periodicity information.

17. The system of claim 15 wherein the sensing operation timing control information comprises an indication that the sensing operation is to be performed on demand from a sensing network function.

18. The system of claim 11, wherein the determination of sensing entities for use in the sensing operation is further based on a sensing service level assigned to each sensing entity.

19. The system of claim 11 wherein the system is further configured to adjust the assignment of sensing entities to the first sensing operation group based on the received sensing measurements.

20. The system of claim 11 wherein the system is further configured to adjust the assignment of sensing entities to the first sensing operation group based on a radio environment in the location for the sensing operation.
